(19) United States
(12) Patent Application Publication
(10) Pub. No.: US 2018/0241967 A1
(43) Pub. Date: Aug. 23, 2018

(54) REMOTE WORK ASSISTANCE DEVICE, INSTRUCTION TERMINAL AND ONSITE TERMINAL

(71) Applicant: MITSUBISHI ELECTRIC CORPORATION, Tokyo (JP)

(72) Inventors: Takeyuki AIKAWA, Tokyo (JP); Yusuke ITANI, Tokyo (JP); Takahiro KASHIMA, Tokyo (JP)

(73) Assignee: MITSUBISHI ELECTRIC CORPORATION, Tokyo (JP)

(21) Appl. No.: 15/772,775

(22) PCT Filed: Mar. 15, 2016
(86) PCT No.: PCT/JP2016/058126

§ 371 Date: May 1, 2018

(51) Int. Cl. H04N 7/14; G06F 3/01; G02B 27/01; G06Q 50/10

(52) U.S. Cl. CPC H04N 7/148; G06F 3/011; G06Q 50/10; G02B 27/017; H04N 7/142

(57) ABSTRACT

An instruction terminal includes a position direction estimating unit to estimate a position and direction of a worker from an image captured by an imaging unit, an onsite situation image generator to generate an image indicating an onsite situation including the position of the worker from the estimation result, a display to display a screen including the generated image; a work instruction accepting unit to accept information indicating a next work position input by a work instructor on the screen; and a direction calculator to calculate a direction to the next work position from the estimation result and the acceptance result. An onsite terminal includes a guide image generator to generate an image indicating the direction to the next work position from the calculation result, and a display to display a screen including the generated image.

### TECHNICAL FIELD

The present invention relates to a remote work assistance device including an onsite terminal having an imaging unit for capturing an image viewed from a worker and an instruction terminal for transmitting and receiving information to and from the onsite terminal, and also to an instruction terminal and an onsite terminal.

### BACKGROUND ART

Maintenance and inspection work is indispensable for operation of machine facilities such as water treatment facilities, plant facilities, and power generation facilities. In this maintenance and inspection work, it is necessary to regularly inspect a large number of devices, accurately record the inspection result, and take countermeasures such as device adjustment as necessary when the inspection result includes a failure. This work includes simple work that can be performed by an unskilled worker and complicated work that is difficult to be performed unless by a skilled worker. However, with a skilled worker assisting onsite work from a remote location, even an unskilled worker can perform complicated work.

As an example of a technique related to remote work assistance as described above, there is a technique disclosed in Patent Literature 1. In this technique, by displaying an image captured by an imaging unit of a head mounted display (hereinafter referred to as HMD) worn by an onsite worker on a screen for a work instructor at a remote location, the onsite worker and the work instructor can share information. In addition, in this technique, the entire image of the entire work target as well as an imaged range of the image out of the entire image is displayed on a sub screen for the work instructor. As a result, even in a case where the onsite worker approaches the work target and only a part of the work target is displayed in the image, the imaged range of the image can be grasped by viewing the entire image.

### CITATION LIST

### Patent Literatures

Patent Literature 1: JP 2014-106888 A

### SUMMARY OF INVENTION

### Technical Problem

However, in the conventional technique disclosed in Patent Literature 1, there is a problem in that information of the site outside the imaging angle of view of the imaging unit cannot be acquired. For this reason, in a case where a work instruction is given concerning a work target at a position away from the onsite worker, for example, the work instructor needs to provide instruction as required in voice such as “Please show me the lower right side.” or instruction to allow a guide image indicating a direction to the work target to be displayed on the HMD. Thus, smooth instruction cannot be performed.

The present invention has been made to solve the problem as described above, and it is an object of the present invention to provide a remote work assistance device, an instruction terminal, and an onsite terminal capable of providing an instruction concerning a work target positioned outside an imaging angle of view of an imaging unit for imaging an onsite image.

### Solution to Problem

A remote work assistance device according to the present invention includes: an onsite terminal having an imaging unit for capturing an image viewed from a worker; and an instruction terminal for transmitting and receiving information to and from the onsite terminal. The instruction terminal includes: a position direction estimating unit for estimating a position and direction of the worker from the image captured by the imaging unit; an onsite situation image generating unit for generating an image indicating an onsite situation including the position of the worker from the estimation result by the position direction estimating unit; an instruction side display unit for displaying a screen including the image generated by the onsite situation image generating unit; a work instruction accepting unit for accepting information indicating a next work position input by a work instructor on the screen displayed by the instruction side display unit; and a direction calculating unit for calculating a direction to the next work position from the estimation result by the position direction estimating unit and the acceptance result by the work instruction accepting unit. The onsite terminal includes: a guide image generating unit for generating an image indicating the direction to the next work position from the calculation result by the direction calculating unit; and an onsite side display unit for displaying a screen including the image generated by the guide image generating unit.

### Advantageous Effects of Invention

According to the present invention, with the configuration above, it is possible to provide an instruction concerning a work target positioned outside an imaging angle of view of the imaging unit for imaging an onsite image.

### BRIEF DESCRIPTION OF DRAWINGS

FIG. 1 is a diagram illustrating an example of an overall configuration of a remote work assistance device according to a first embodiment of the present invention.

FIG. 2A is a diagram illustrating an exemplary hardware configuration of an onsite terminal and an instruction terminal according to the first embodiment of the present invention, and FIG. 2B is a diagram illustrating details of an exemplary hardware configuration of the onsite terminal.

FIG. 3 is a block diagram illustrating an exemplary hardware configuration of the onsite terminal and the instruction terminal according to the first embodiment of the present invention.

FIG. 4 is a block diagram illustrating another exemplary hardware configuration of the onsite terminal and the instruction terminal according to the first embodiment of the present invention.

FIG. 5 is a diagram illustrating another exemplary hardware configuration of the onsite terminal according to the first embodiment of the present invention.

FIG. 6 is a flowchart illustrating an example of overall processing by a remote work assistance device according to the first embodiment of the present invention.

FIG. 7 is a flowchart illustrating an example of onsite situation displaying processing by the instruction terminal according to the first embodiment of the present invention.

FIG. 8 is a table illustrating an example of work location data stored the instruction terminal according to the first embodiment of the present invention.

FIG. 9 is a diagram illustrating an example of an onsite situation screen displayed on the instruction terminal according to the first embodiment of the present invention.

FIG. 10 is a flowchart illustrating an example of work instruction accepting processing by the instruction terminal according to the first embodiment of the present invention.

FIG. 11 is a diagram illustrating an example of a work instruction screen by the instruction terminal according to the first embodiment of the present invention.

FIG. 12 is a flowchart illustrating an example of processing by a direction calculating unit in the first embodiment of the present invention.

FIG. 13 is a flowchart illustrating an example of information presentation processing by the onsite terminal according to the first embodiment of the present invention.

FIG. 14 is a flowchart illustrating an example of processing by a guide image generating unit in the first embodiment of the present invention.

FIG. 15 is a diagram illustrating an example of an information presenting screen displayed on the onsite terminal according to the first embodiment of the present invention.

FIG. 16 is a diagram illustrating another example of the information presenting screen displayed on the onsite terminal according to the first embodiment of the present invention.

FIG. 17 is a diagram illustrating an example of the overall configuration of a remote work assistance device according to a second embodiment of the present invention.

FIG. 18 is a flowchart illustrating an example of work instruction accepting processing by an instruction terminal according to the second embodiment of the present invention.

FIG. 19 is a diagram illustrating an example of an instruction input screen by the instruction terminal according to the second embodiment of the present invention.

FIG. 20 is a flowchart illustrating an example of processing by a direction calculating unit in the second embodiment of the present invention.

FIG. 21 is a diagram illustrating an example of the overall configuration of a remote work assistance device according to a third embodiment of the present invention.

FIG. 22 is a flowchart illustrating an example of work instruction accepting processing by an instruction terminal according to the third embodiment of the present invention.

FIG. 23 is a flowchart illustrating an example of processing by a direction calculating unit in the third embodiment of the present invention.

FIG. 24 is a flowchart illustrating an example of information presentation processing by an onsite terminal according to the third embodiment of the present invention.

FIG. 25 is a flowchart illustrating an example of processing by a guide image generating unit in the third embodiment of the present invention.

FIG. 26 is a diagram illustrating an example of an information presenting screen displayed on the onsite terminal according to the third embodiment of the present invention.

### DESCRIPTION OF EMBODIMENTS

Hereinafter, embodiments of the invention will be described in detail with reference to the drawings.

### First Embodiment

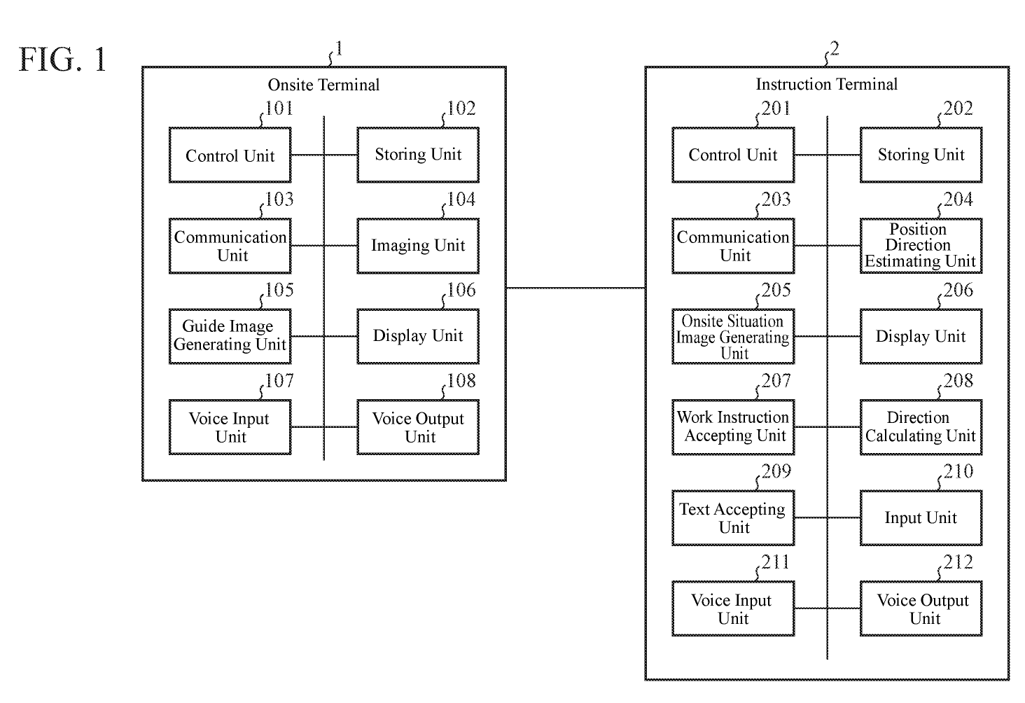

FIG. 1 is a diagram illustrating an example of the overall configuration of a remote work assistance device according to a first embodiment of the present invention.

The remote work assistance device allows a work instructor who is a skilled worker to assist onsite work from a remote location such that maintenance and inspection work, correction work, installation work, or other work of machine facilities can be performed even when a worker at a site (hereinafter referred to as onsite worker) is an unskilled worker. As illustrated in FIG. 1, this remote work assistance device includes an onsite terminal 1 used by an onsite worker actually performing work at a site and an instruction terminal 2 for allowing a work instructor to assist work by providing an instruction to the onsite worker from a remote location.

As illustrated in FIG. 1, the onsite terminal 1 includes a control unit 101, a storing unit 102, a communication unit 103, an imaging unit 104, a guide image generating unit 105, a display unit (onsite side display unit) 106, a voice input unit 107, and a voice output unit 108.

The control unit 101 controls operations of each unit in the onsite terminal 1.

The storing unit 102 stores information used by the onsite terminal 1. In the storing unit 102, for example, preliminary registration information used for display on a display 33, which will be described later, by the display unit 106, information transmitted and received by the communication unit 103, or other information are stored.

The communication unit 103 transmits and receives information to and from a communication unit 203 of the instruction terminal 2. Here, the communication unit 103 transmits, to the communication unit 203, information (image data) indicating an image captured by the imaging unit 104 and information (voice data) indicating voice input to the voice input unit 107. The communication unit 103 further receives work instruction data, text information, and voice data from the communication unit 203. Note that the work instruction data is information indicating a direction from a current position of the onsite worker to a next work position.

The imaging unit 104 captures an image of the site as viewed from the onsite worker.

The guide image generating unit 105 generates an image (guide image) indicating a direction from the current position of the onsite worker to a next work position on the basis of the work instruction data received by the communication unit 103. Note that the guide image may be a mark like an arrow, for example.

The display unit 106 displays various screens on the display 33. Here, in a case where the guide image is generated by the guide image generating unit 105, the display unit 106 displays a screen (information presenting screen) including the guide image on the display 33. Moreover, in a case where text information is received by the communication unit 103, the display unit 106 displays a screen (information presenting screen) including a text indicated by the text information on the display 33. Note that the guide image and the text information may be displayed on the same screen.

The voice input unit 107 receives voice input from the onsite worker.

The voice output unit 108 reproduces voice data when the voice data is received by the communication unit 103.

As illustrated in FIG. 1, the instruction terminal 2 includes a control unit 201, a storing unit 202, the communication unit 203, a position direction estimating unit 204, an onsite situation image generating unit 205, a display unit (instruction display unit) 206, a work instruction accepting unit 207, a direction calculating unit 208, a text accepting unit 209, an input unit 210, a voice input unit 211, and a voice output unit 212.

The control unit 201 controls operations of each unit in the instruction terminal 2.

The storing unit 202 stores information used in the instruction terminal 2. In the storing unit 202, for example, work location data used by the position direction estimating unit 204 and the onsite situation image generating unit 205 or information transmitted and received by the communication unit 203 are stored. Note that work location data defines various devices present at the work site as point group data which is a set of three-dimensional coordinate values and further associates image feature points obtained from an image imaging the site to the point group data.

The communication unit 203 transmits and receives information to and from the communication unit 103 of the onsite terminal 1. In the first embodiment, here the communication unit 203 transmits, to the communication unit 103, information (work instruction data) indicating the direction from the current position of the onsite worker to the next work position calculated by the direction calculating unit 208, information (text information) indicating a text accepted by the text accepting unit 209, and information (voice data) indicating voice input to the voice input unit 211. The communication unit 203 further receives the image data and the voice data from the communication unit 103.

The position direction estimating unit 204 estimates the current position of the onsite worker and a direction in which the onsite worker is facing on the basis of the image data received by the communication unit 203. At this time, the position direction estimating unit 204 estimates the current position of the onsite worker and the direction in which the onsite worker is facing by comparing the image indicated by the image data with the work location data stored in advance in the storing unit 202.

The onsite situation image generating unit 205 generates an image (onsite situation image) indicating the onsite situation including the current position of the onsite worker on the basis of the estimation result by the position direction estimating unit 204.

The display unit 206 displays various screens on a display 6 which will be described later. Here, in the case where the onsite situation image is generated by the onsite situation image generating unit 205, the display unit 206 displays a screen (onsite situation screen) including the onsite situation image on the display 6. Moreover, in a case where the work instructor requests to start a work instruction via the input unit 210, a screen for performing a work instruction (work instruction screen) is displayed on the display 6 using the onsite situation image generated by the onsite situation image generating unit 205.

The work instruction accepting unit 207 accepts information indicating a next work position input by the work instructor via the input unit 210. At this time, the work instructor designates the next work position using the work instruction screen displayed on the display 6 by the display unit 206.

The direction calculating unit 208 calculates a direction from the current position of the onsite worker to the next work position on the basis of the estimation result by the position direction estimating unit 204 and the acceptance result by the work instruction accepting unit 207.

The text accepting unit 209 accepts information indicating a text input by the work instructor via the input unit 210.

The input unit 210 is used when the work instructor inputs various information to the instruction terminal 2.

The voice input unit 211 receives voice input from the work instructor.

The voice output unit 212 reproduces voice data when the voice data is received by the communication unit 203.

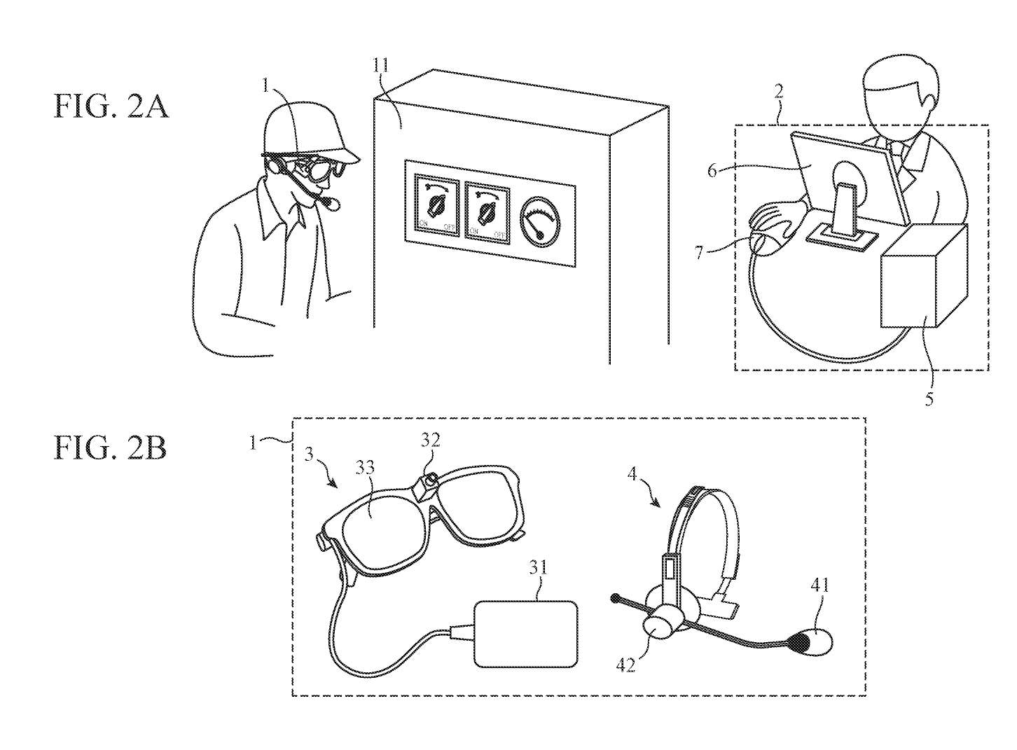

Next, exemplary hardware configurations of the onsite terminal 1 and the instruction terminal 2 will be described with reference to FIGS. 2 to 4.

First, an exemplary hardware configuration of the onsite terminal 1 will be described.

As illustrated in FIG. 2, the respective functions of the onsite terminal 1 is implemented by an HMD 3 and a headset 4. The onsite worker performs various types of work on a work target while wearing the HMD 3 and the headset 4. Note that in the example of FIG. 2, a case where inspection work or other work is performed on a switchboard 11 is illustrated.

As illustrated in FIGS. 2 to 4, the HMD 3 includes a terminal unit 31, an imaging device 32, and the display 33. The terminal unit 31 further includes a processing circuit 311, a storing device 312, and a communication device 313. Moreover, as illustrated in FIGS. 2 to 4, the headset 4 includes a microphone 41 and a speaker 42.

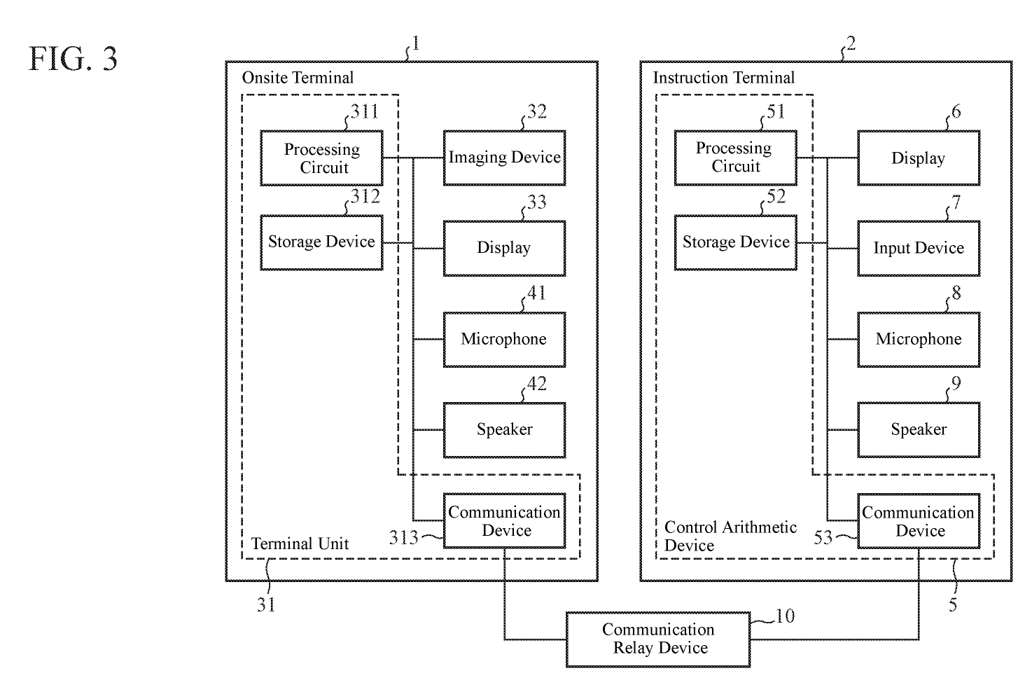

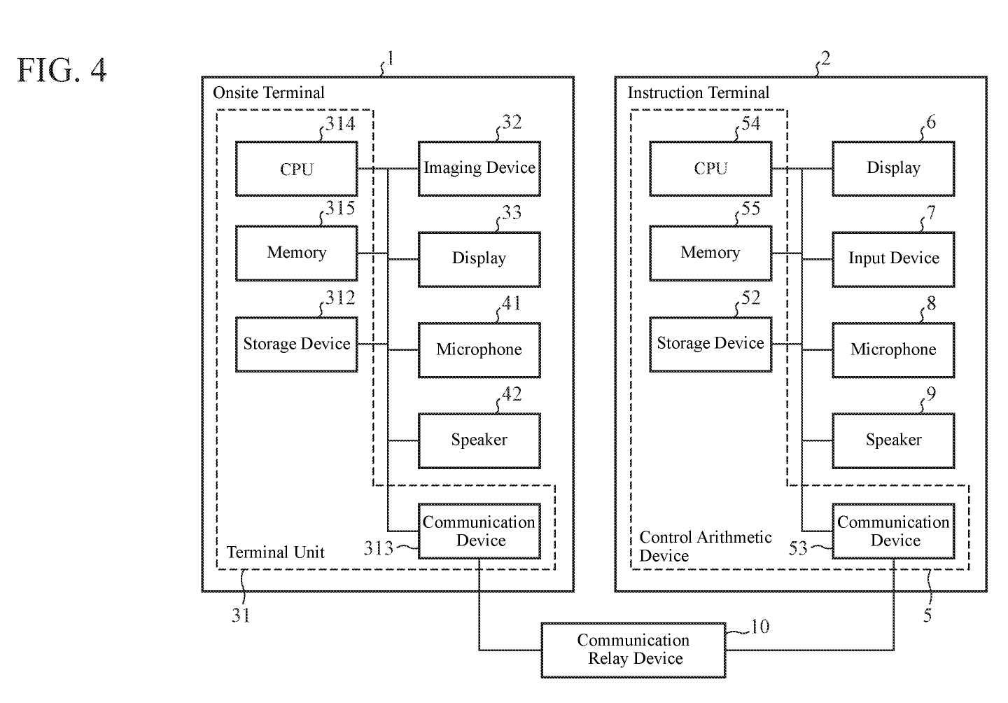

The processing circuit 311 implements the respective functions of the control unit 101, the guide image generating unit 105, and the display unit 106 and executes various processing on the HMD 3. As illustrated in FIG. 3, the processing circuit 311 may be dedicated hardware. Alternatively, as illustrated in FIG. 4, the processing circuit 311 may be a CPU (also referred to as a central processing unit, a central processing device, a processing device, an arithmetic device, a microprocessor, a microcomputer, a processor, or a digital signal processor (DSP)) 314 for executing a program stored in a memory 315.

In a case where the processing circuit 311 is dedicated hardware, the processing circuit 311 corresponds to, for example, a single circuit, a composite circuit, a programmed processor, a parallel programmed processor, an application specific integrated circuit (ASIC), a field-programmable gate array (FPGA), or a combination thereof. Functions of the control unit 101, the guide image generating unit 105, and the display unit 106 may be separately implemented by the processing circuit 311. Alternatively, the functions of respective units may be collectively implemented by the processing circuit 311.

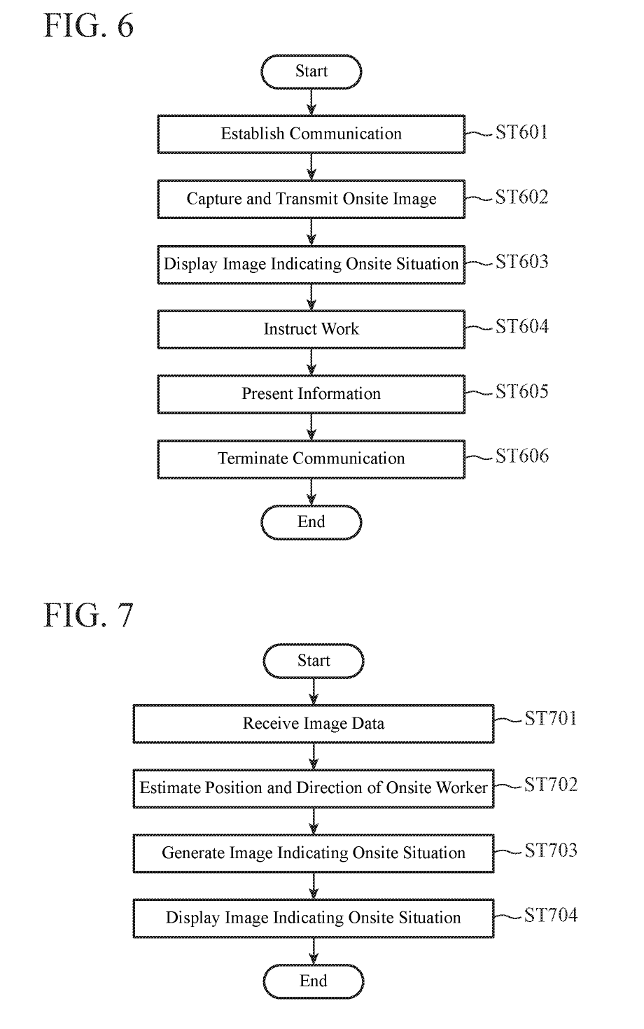

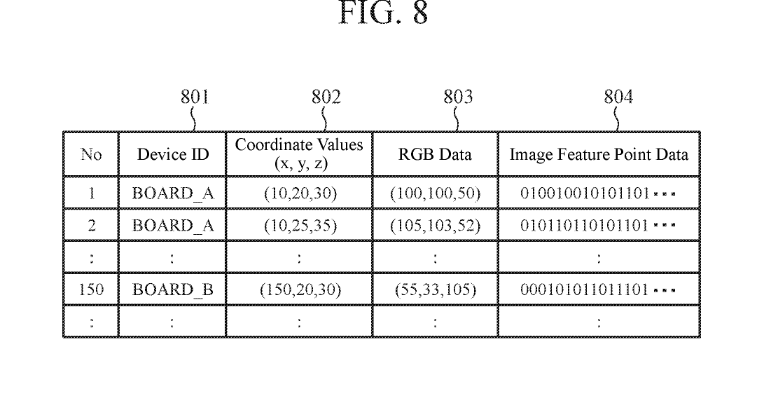

When the processing circuit 311 is the CPU 314, the functions of the control unit 101, the guide image generating unit 105, and the display unit 106 are implemented by software, firmware, or a combination of software and firmware. Software or firmware is described as a program and stored in the memory 315. The processing circuit 311 reads and executes a program stored in the memory 315 and thereby implements functions of respective units. That is, the onsite terminal 1 includes the memory 315 for storing a program, and when the program is executed by the processing circuit 311, for example respective steps illustrated in FIGS. 6 and 13, which will be described later, are executed as a result. These programs also cause a computer to execute a procedure or a method of the control unit 101, the guide image generating unit 105, and the display unit 106. Here, the memory 315 may be a nonvolatile or volatile semiconductor memory such as a random access memory (RAM), a read only memory (ROM), a flash memory, an erasable programmable ROM (EPROM), or an electrically EPROM (EEPROM), a magnetic disk, a flexible disc, an optical disc, a compact disc, a mini disc, or a digital versatile disc (DVD).

Note that some of the functions of the control unit 101, the guide image generating unit 105, and the display unit 106 may be implemented by dedicated hardware, and another part thereof may be implemented by software or firmware. For example, the function of the control unit 101 may be implemented by the processing circuit 311 as dedicated hardware while the functions of the guide image generating unit 105 and the display unit 106 may be implemented by the processing circuit 311 reading and executing a program stored in the memory 315.

In this manner, the processing circuit 311 can implement the functions described above by hardware, software, firmware, or a combination thereof.

The storing device 312 implements the function of the storing unit 102. Here, the storing device 312 may be a nonvolatile or a volatile semiconductor memory such as a RAM, a flash memory, an EPROM, an EEPROM, a magnetic disk, a flexible disc, an optical disc, a compact disc, a mini disc, a DVD, or the like.

The communication device 313 implements the function of the communication unit 103. A communication method and the shape of this communication device 313 are not limited.

The imaging device 32 implements the function of the imaging unit 104. Note that the imaging device 32 is only required to be mountable on the HMD 3, and thus an imaging method and the shape thereof are not limited.

The display 33 displays various screens by the display unit 106. The display 33 is only required to be mountable on the HMD 3, and thus a displaying method and the shape thereof are not limited. A display method of the display 33 may be, for example, a method of projecting a projector image on glass using a semitransparent mirror, a projection method using interference of laser light, a method of using a small liquid crystal display, and the like.

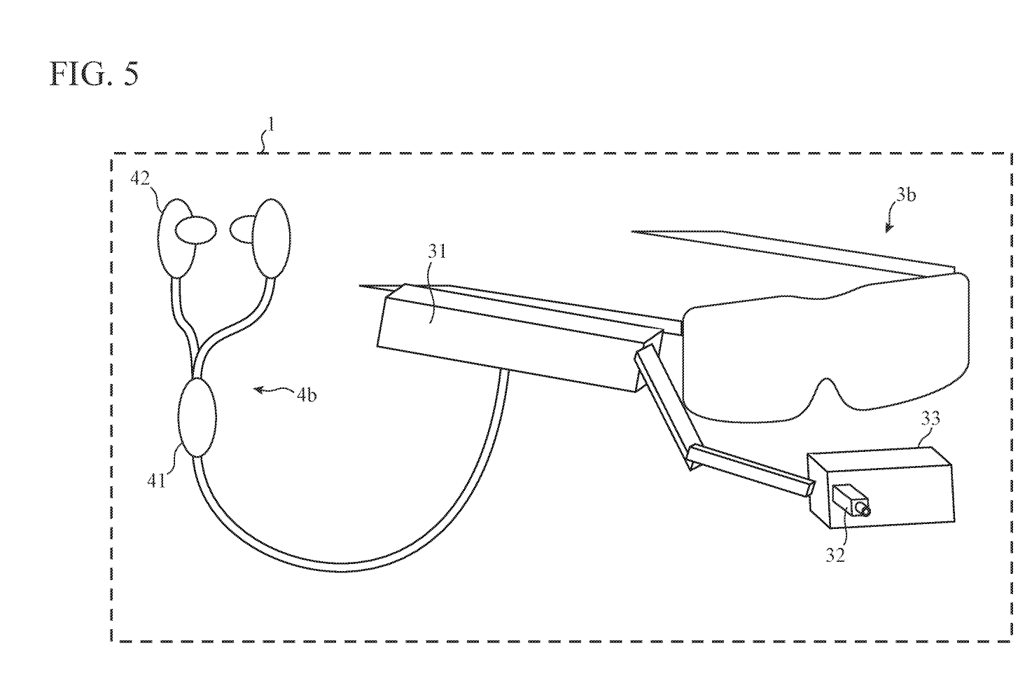

The microphone 41 implements the function of the voice input unit 107. In addition, the speaker 42 implements the function of the voice output unit 108. The shape of the microphone 41 and the speaker 42 is not limited. For example, a headset 4 (see FIG. 2) in which the microphone 41 and the speaker 42 are integrated may be employed. Alternatively, an earphone microphone 4b in which the microphone 41 is mounted on a cable of the earphones (see FIG. 5), or other shapes may be employed.

Next, an exemplary hardware configuration of the instruction terminal 2 will be described.

As illustrated in FIGS. 2 to 4, the respective functions of the instruction terminal 2 are implemented by the control arithmetic device 5, the display 6, the input device 7, the microphone 8, and the speaker 9. The control arithmetic device 5 further includes a processing circuit 51, a storing device 52, and a communication device 53. In FIG. 2, illustration of the microphone 8 and the speaker 9 is omitted.

The processing circuit 51 implements the functions of the control unit 201, the position direction estimating unit 204, the onsite situation image generating unit 205, the display unit 206, the work instruction accepting unit 207, the direction calculating unit 208, and the text accepting unit 209 and executes various processing on the instruction terminal 2. As illustrated in FIG. 3, the processing circuit 51 may be dedicated hardware. Alternatively, as illustrated in FIG. 4, the processing circuit 51 may be a CPU (also referred to as a central processing unit, a processing device, an arithmetic device, a microprocessor, a microcomputer, a processor, or a DSP) 54 for executing a program stored in a memory 55.

In a case where the processing circuit 51 is dedicated hardware, the processing circuit 51 corresponds to, for example, a single circuit, a composite circuit, a programmed processor, a parallel programmed processor, an ASIC, an FPGA, or a combination thereof. Functions of the control unit 201, the position direction estimating unit 204, the onsite situation image generating unit 205, the display unit 206, the work instruction accepting unit 207, the direction calculating unit 208, and the text accepting unit 209 may be separately implemented by the processing circuit 51. Alternatively, the functions of respective units may be collectively implemented by the processing circuit 51.

When the processing circuit 51 is the CPU 54, the functions of the control unit 201, the position direction estimating unit 204, the onsite situation image generating unit 205, the display unit 206, the work instruction accepting unit 207, the direction calculating unit 208, and the text accepting unit 209 are implemented by software, firmware, or a combination of software and firmware. Software or firmware is described as a program and stored in the memory 55. The processing circuit 51 reads and executes a program stored in the memory 55 and thereby implements functions of respective units. That is, the instruction terminal 2 includes the memory 55 for storing a program. When the program is executed by the processing circuit 51, for example respective steps illustrated in FIGS. 6, 7, and 10, which will be described later, are executed as a result. These programs also cause a computer to execute a procedure or a method of the control unit 201, the position direction estimating unit 204, the onsite situation image generating unit 205, the display unit 206, the work instruction accepting unit 207, the direction calculating unit 208, and the text accepting unit 209. Here, the memory 55 may be a nonvolatile or a volatile semiconductor memory such as a RAM, a ROM, a flash memory, an EPROM, an EEPROM, a magnetic disk, a flexible disc, an optical disc, a compact disc, a mini disc, a DVD, or the like.

Note that some of the functions of the control unit 201, the position direction estimating unit 204, the onsite situation image generating unit 205, the display unit 206, the work instruction accepting unit 207, the direction calculating unit 208, and the text accepting unit 209 may be implemented by dedicated hardware, and another part thereof may be implemented by software or firmware. For example, the function of the control unit 201 may be implemented by the processing circuit 51 as dedicated hardware while the functions of the position direction estimating unit 204, the onsite situation image generating unit 205, the display unit 206, the work instruction accepting unit 207, the direction calculating unit 208, and the text accepting unit 209 may be implemented by the processing circuit 51 reading and executing a program stored in the memory 55.

In this manner, the processing circuit 51 can implement the functions described above by hardware, software, firmware, or a combination thereof.

The storing device 52 implements the function of the storing unit 202. Here, the storing device 52 may be a nonvolatile or a volatile semiconductor memory such as a RAM, a flash memory, an EPROM, an EEPROM, a magnetic disk, a flexible disc, an optical disc, a compact disc, a mini disc, a DVD, or the like.

The communication device 53 implements the function of the communication unit 203. A communication method and the shape of this communication device 53 are not limited.

The display 6 displays various screens by the display unit 206. The display 6 is only required to be a monitor device on which the work instructor can view or may be a liquid crystal monitor device, a tablet device, or other devices, and a display method and the shape thereof are not limited.

The input device 7 implements the function of the input unit 210. The input device 7 may be any device such as a keyboard, a mouse or a touch pen as long as the device is capable of inputting characters and coordinate values.

The microphone 8 implements the function of the voice input unit 211. In addition, the speaker 9 implements the function of the voice output unit 212. The shape of the microphone 8 and the speaker 9 is not limited. For example, a headset in which the microphone 8 and the speaker 9 are integrated may be employed. Alternatively, an earphone microphone in which the microphone 8 is mounted on a cable of the earphones or other shapes may be employed.

In the configurations illustrated in FIGS. 3 and 4, a communication relay device 10 is provided. This communication relay device 10 secures a communication path from the onsite terminal 1 to the instruction terminal 2 at a remote location. The communication relay device 10 may be any device as long as the device is capable of being connected via a wide area communication network, and a communication method, such as wireless LAN, wired LAN, or infrared communication is not limited, and the shape thereof is also not limited.

Moreover, one of the onsite terminal 1 and the instruction terminal 2 may have the hardware configuration illustrated in FIG. 3 while the other one may have the hardware configuration illustrated in FIG. 4.

Furthermore, the control arithmetic device 5 may be divided into a plurality of units, and processing with a higher load may be performed by the control arithmetic device 5 capable of performing large-scale calculation processing.

In addition, the onsite terminal 1 is not limited to the configuration illustrated in FIG. 2. For example, a monocular HMD 3b as illustrated in FIG. 5 may be used. Note that, in the configuration illustrated in FIG. 5, a case where the earphone microphone 4b is used as the configuration of the microphone 41 and the speaker 42 is illustrated.

Next, an exemplary operation of the remote work assistance device according to the first embodiment will be described with reference to FIGS. 1 to 16.

First, an example of overall processing by the remote work assistance device will be described with reference to FIG. 6.

In the example of the overall processing by the remote work assistance device, as illustrated in FIG. 6, first the communication unit 103 and the communication unit 203 establish communication between the onsite terminal 1 and the instruction terminal 2 (step ST601). Note that the communication establishing processing described above may be automatically performed when it is determined that the onsite worker is positioned at the work site by the GPS, an image by the imaging unit 104, wireless LAN communication, or other means or in response to an entry notification of the onsite worker in conjunction with a security system of the work site.

Next, the onsite terminal 1 captures an onsite image viewed from the onsite worker and transmits the image to the instruction terminal 2 (step ST602). That is, first, the imaging unit 104 captures the onsite image viewed from the onsite worker by the imaging device 32 mounted on the HMD 3. Note that it is preferable that the image captured by the imaging unit 104 is a video (15 fps or more). However, in a case where a hardware resource or a communication band is insufficient, a series of still images captured at a constant cycle (4 to 5 fps) may be used. Then, the communication unit 103 transmits information (image data) indicating the image captured by the imaging unit 104 to the communication unit 203. Note that this image transmission processing is continuously performed while communication between the onsite terminal 1 and the instruction terminal 2 is established.

Next, using the image data from the onsite terminal 1, the instruction terminal 2 generates an image indicating the onsite situation including the current position of the onsite worker and displays the image (step ST603). Details of the onsite situation displaying processing in step ST603 will be described later. Note that the onsite situation displaying processing is continuously performed while the communication between the onsite terminal 1 and the instruction terminal 2 is established.

Subsequently, the instruction terminal 2 accepts a work instruction for the onsite worker input by the work instructor and notifies the onsite terminal 1 (step ST604). Details of the work instruction accepting processing in this step ST604 will be described later.

Next, the onsite terminal 1 displays a screen indicating the work instruction using information indicating the work instruction from the instruction terminal 2 (step ST605). Details of the information presentation processing in step ST605 will be described later.

Thereafter, the onsite worker moves to the work position and performs work in accordance with the screen displayed on the display 33 of the onsite terminal 1. Then, the above processing is repeated until all the work is completed.

Then, the communication unit 103 and the communication unit 203 disconnect the communication between the onsite terminal 1 and the instruction terminal 2 (step ST606). As a result, the work assistance for the onsite worker is terminated.

Next, the details of the onsite situation displaying processing in step ST603 will be described with reference to FIG. 7.

In the onsite situation displaying processing by the instruction terminal 2, as illustrated in FIG. 7, the communication unit 203 first receives image data from the communication unit 103 (step ST701).

Next, on the basis of the image data received by the communication unit 203, the position direction estimating unit 204 estimates the current position of the onsite worker and the direction in which the onsite worker is facing (step ST702). At this time, the position direction estimating unit 204 collates the image indicated by the image data with the work location data stored in advance in the storing unit 202 and thereby estimates at which position the onsite worker is in the work site and in which direction the onsite worker is facing.

FIG. 8 is a table illustrating an example of work location data stored in the storing unit 202.

In the work location data illustrated in FIG. 8, for each defined point, a device ID 801, coordinate values 802, RGB data 803, and an image feature point data 804 are registered in association therewith. Note that the device ID 801 identifies which device on the work site a defined point belongs to. The coordinate values 802 are coordinate values in a three-dimensional space indicating which position on the work site a defined point is at. Note that the origin of a coordinate system is defined as appropriate for each work site such as the center of an entrance/exit of the work site or a corner of a room. The RGB data 803 is color information of a defined point, which is obtained from an image previously captured. The image feature point data 804 indicates the image feature amount of a defined point and is calculated on the basis of RGB data 803 or other information of another point near the defined point. For example, concerning a set Bi of other points within a predetermined distance from a point A, a distribution of luminance differences between the point A and the set Bi can be defined as the image feature amount of the point A.

Note that as the estimation processing by the position direction estimating unit 204, for example, a method disclosed in Patent Literature 2 can be used. Here it is assume that, as the estimation result, the position direction estimating unit 204 obtains coordinate values P0 (X₀, Y₀, Z₀) indicating the current position of the onsite worker, a direction vector Vc (Xc, Yc, Zc) representing a direction in which the onsite worker is facing (direction of the imaging device 32), an inclination θ_{H} in the horizontal direction, and an inclination θ_{V} in the vertical direction.

Patent Literature 2: JP 2013-054661 A

Subsequently, on the basis of the estimation result by the position direction estimating unit 204, the onsite situation image generating unit 205 generates an image indicating the onsite situation including the current position of the onsite worker (step ST703). That is, the onsite situation image generating unit 205 generates an image in which devices around the work site are reproduced in a virtual space, and the current location of the onsite worker is indicated in the virtual space, by using the estimation result and the work location data.

Next, on the basis of the image illustrating the onsite situation generated by the onsite situation image generating unit 205, the display unit 206 displays a screen (onsite situation screen) including the image on the display 6 (step ST704).

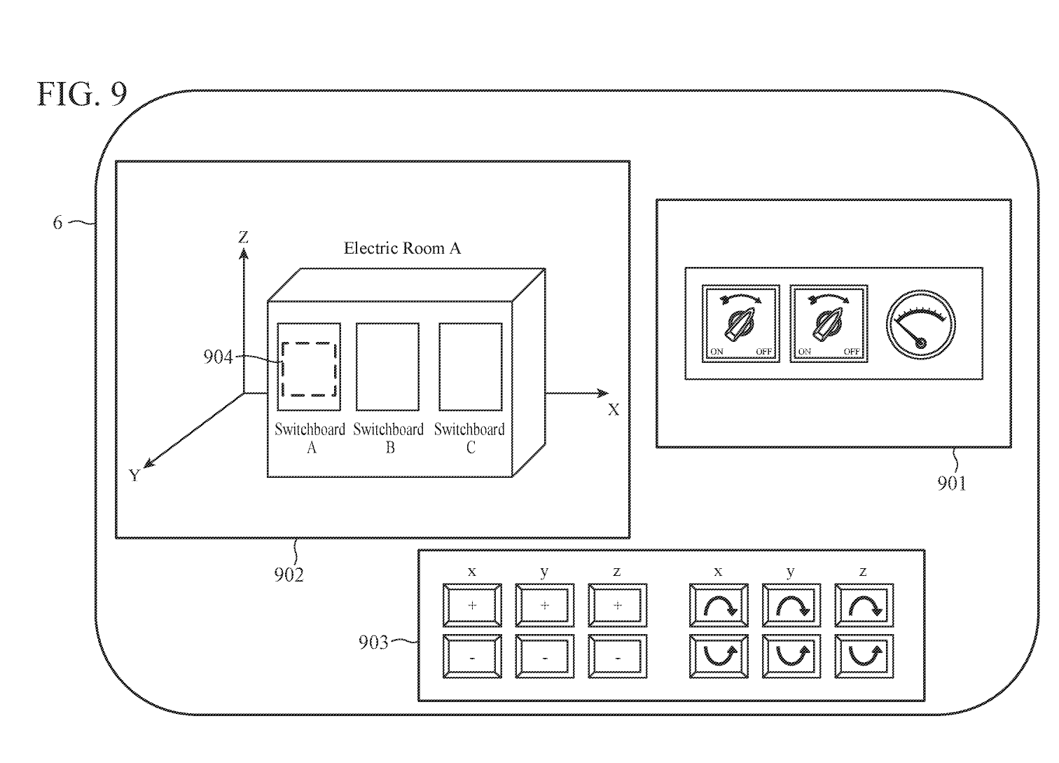

FIG. 9 is a diagram illustrating one example of an onsite situation screen displayed by the display unit 206.

On the onsite situation screen illustrated in FIG. 9, an onsite image 901, a virtual onsite image 902, and an operation button 903 are displayed. Note that the onsite image 901 is the image indicated by the image data received by the communication unit 203. Moreover, the virtual onsite image 902 is the image in which the devices around the work site are reproduced in the virtual space, and which is generated by the onsite situation image generating unit 205. Also, in this virtual onsite image 902, a frame line 904 indicating which part thereof corresponds to the onsite image 901 is illustrated. This frame line 904 enables the current position of the onsite worker to be grasped. The operation button 903 is a button image for moving the viewpoint in the virtual onsite image 902. The operation button 903 illustrated in FIG. 9 enables the virtual onsite image 902 to be manipulated forward and backward in the axial (X, Y, Z) directions and rotation and counter rotation about each of the axes. Alternatively, a viewpoint in the virtual onsite image 902 may be moved by dragging operation of one point on the virtual onsite image 902 with a mouse instead of operating buttons using the operation button 903 as illustrated in FIG. 9.

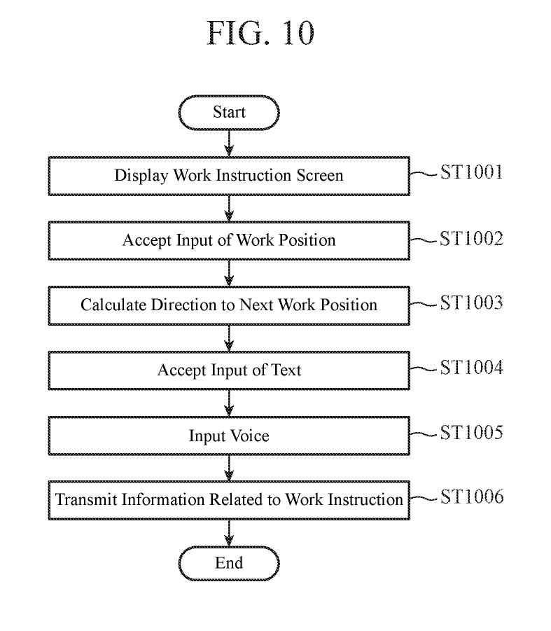

Next, details of the work instruction accepting processing in step ST604 will be described with reference to FIG. 10.

In the work instruction accepting processing by the instruction terminal 2, as illustrated in FIG. 10, the display unit 206 is first requested to start a work instruction by the work instructor via the input unit 210 and thereby displays a screen (work instruction screen) for performing work instructions on the display 6 using the image indicating the onsite situation generated by the onsite situation image generating unit 205 (step ST1001).

Next, the work instruction accepting unit 207 accepts information indicating the next work position input by the work instructor via the input unit 210 (step ST1002). At this time, the work instructor designates the next work position using the work instruction screen displayed on the display 6 by the display unit 206.

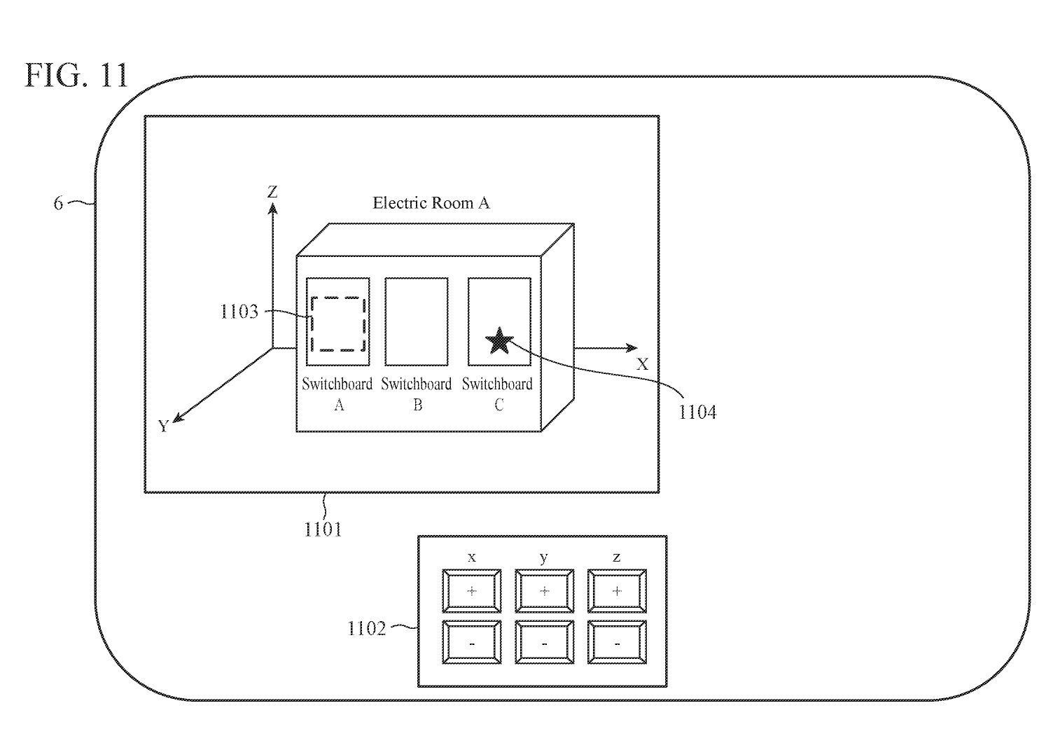

FIG. 11 is a diagram illustrating one example of a work instruction screen displayed by the display unit 206.

In the work instruction screen illustrated in FIG. 11, a virtual onsite image 1101 and an operation button 1102 are displayed. Note that the virtual onsite image 1101 is an image for the work instructor to designate a next work position and is a similar image to the virtual onsite image 902 in FIG. 9. Note that symbol 1103 is a frame line indicating which part corresponds to the onsite image 901 (to grasp the current position of the onsite worker). Furthermore, in the virtual onsite image 1101, a work position marker 1104 indicating the next work position is added. The operation button 1102 is a button image for moving the work position marker 1104. In the operation button 1102 illustrated in FIG. 11, forward or backward operation of the work position marker 1104 can be performed in the axial directions (X, Y, Z). Then, the work instructor moves the work position marker 1104 by operating the operation button 1102 to designate a work position (coordinate values P1 (X₁, Y₁, Z₁)) to which the onsite worker should pay attention next. Alternatively, instead of button operation using the operation button 1102 as illustrated in FIG. 11, the work position marker 1104 may be moved by dragging operation on the work position marker 1104 with a mouse.

In this manner, by displaying the work instruction screen on the display 6 using the image generated by the onsite situation image generating unit 205, it is possible to provide an instruction concerning the work target positioned outside an imaging angle of view of the imaging unit 104 for imaging an onsite image.

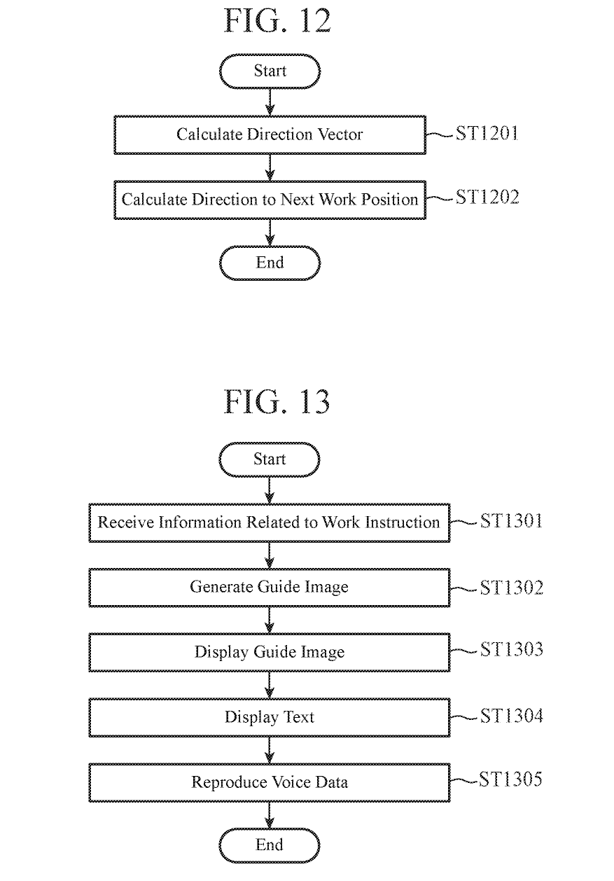

Next, the direction calculating unit 208 calculates a direction from the current position of the onsite worker to the next work position on the basis of the estimation result by the position direction estimating unit 204 and the acceptance result by the work instruction accepting unit 207 (step ST1003). Details of the calculation processing by the direction calculating unit 208 will be described below with reference to FIG. 12.

As illustrated in FIG. 12, in the calculation processing by the direction calculating unit 208 first a direction vector Vd (Xd, Yd, Zd) from P0 (X₀, Y₀, Z₀) to P1 (X₁, Y₁, Z₁) is calculated on the basis of the current position (coordinate values P0 (X₀, Y₀, Z₀)) of the onsite worker and the next work position (coordinate values P1 (X₁, Y₁, Z₁) (step ST1201).

Next, on the basis of the calculated direction vector Vd (Xd, Yd, Zd) and the direction in which the onsite worker is facing (direction vector Vc (Xc, Yc, Zc)), the direction calculating unit 208 calculates a direction to the next work position (step ST1202). Specifically, the direction vector Vd (Xd, Yd, Zd) is projected on a plane having the direction vector Vc (Xc, Yc, Zc) as a normal vector thereto, and a direction θ_{d} from the center point of the onsite image (image captured by the imaging unit 104) is obtained. At this time, the inclination OH in the horizontal direction and the inclination θ_{V} in the vertical direction of the imaging device 32 estimated by the position direction estimating unit 204 may be modified considering the inclination of the head of the onsite worker.

Returning to the explanation of the work instruction accepting processing illustrated in FIG. 10 again, the text accepting unit 209 accepts information indicating the text input by the work instructor via the input unit 210 (step ST1004). At this time, the work instructor inputs the text while watching the onsite situation screen or the work instruction screen displayed by the display unit 206. This text may be a character string input by a work instructor using a keyboard or may be ink data input using a touch pen. Alternatively, a fixed text registered in advance may be selected from a selection menu by mouse operation. Note that when it is determined by the work instructor that an instruction by a text is not necessary, the processing by the text accepting unit 209 is not performed.

Moreover, the voice input unit 211 receives voice input from the work instructor (step ST1005). At this time, the work instructor inputs voice while watching the onsite situation screen or the work instruction screen displayed by the display unit 206. Note that when it is determined by the work instructor that an instruction by voice is not necessary, the processing by the voice input unit 211 is not performed.

Next, the communication unit 203 transmits information on the work instruction to the communication unit 103 (step ST1006). At this time, the communication unit 203 transmits information (instruction data) indicating the calculation result by the direction calculating unit 208 to the communication unit 103. In a case where a text is input to the text accepting unit 209, information (text information) indicating the text is also transmitted to the communication unit 103. Furthermore, in a case where voice is input to the voice input unit 211, information indicating the voice (voice data) is also transmitted to the communication unit 103.

Thereafter, the above processing is repeated until it is determined by the work instructor that the work instruction is not necessary.

Next, the information presentation processing in step ST605 will be described with reference to FIG. 13.

In the information presentation processing by the onsite terminal 1, as illustrated in FIG. 13, the communication unit 103 first receives information on a work instruction from the communication unit 203 (step ST1301). At this time, the communication unit 103 receives instruction data from the communication unit 203. Furthermore, in a case where text information is transmitted from the communication unit 203, the communication unit 103 also receives the text information. Furthermore, in a case where voice data is transmitted from the communication unit 203, the communication unit 103 also receives the voice data.

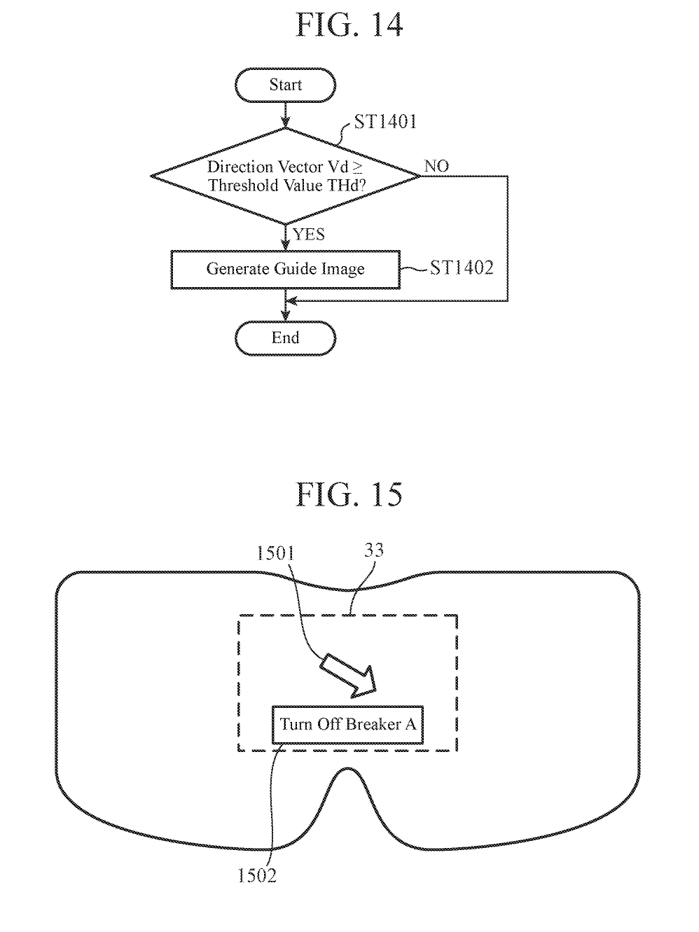

Next, on the basis of the work instruction data received by the communication unit 103, the guide image generating unit 105 generates a guide image indicating a direction from the current position of the onsite worker to the next work position (step ST1302). Details of the guide image generating processing by the guide image generating unit 105 will be described below with reference to FIG. 14.

In the guide image generating processing by the guide image generating unit 105, as illustrated in FIG. 14, it is first determined on the basis of the work instruction data whether the direction vector Vd is larger than or equal to a predetermined threshold value THd (step ST1401). That is, the guide image generating unit 105 determines whether the onsite worker has reached the next work position by determining whether the direction vector Vd is larger than or equal to the threshold value Thd. If it is determined in step ST1401 that the direction vector Vd is less than the threshold value THd, the guide image generating unit 105 determines that the onsite worker has reached the next work position and that displaying the guide image is unnecessary and terminates the processing.

On the other hand, if it is determined in step ST1401 that the direction vector Vd is equal to or larger than the threshold value THd, the guide image generating unit 105 generates a guide image indicating the direction from the current position of the onsite worker to the next work position (Step ST1402). Note that the guide image may be a mark like an arrow, for example.

Returning to the description of the information presentation processing illustrated in FIG. 13 again, the display unit 106 displays a screen (information presenting screen) including the guide image on the display 33 on the basis of the guide image generated by the guide image generating unit 105 (Step ST1303).

Moreover, in a case where text information is received by the communication unit 103, the display unit 106 displays a screen (information presenting screen) including a text indicated by the text information on the display 33 (step ST1304).

FIG. 15 is a diagram illustrating one example of an information presenting screen displayed by the display unit 106.

On the information presenting screen illustrated in FIG. 15, a guide image 1501 and a text 1502 are displayed. In the guide image 1501 illustrated in FIG. 15, an arrow indicating the direction from the current position of the onsite worker to the next work position is displayed. Thus, the onsite worker can move to next work by looking at the guide image 1501 and the text 1502.

Note that a direction from the current position of the onsite worker to the next work position is automatically calculated when the work instructor only designates the work position, and thus the work instructor is not required to sequentially instruct next work positions. This enables smooth communication.

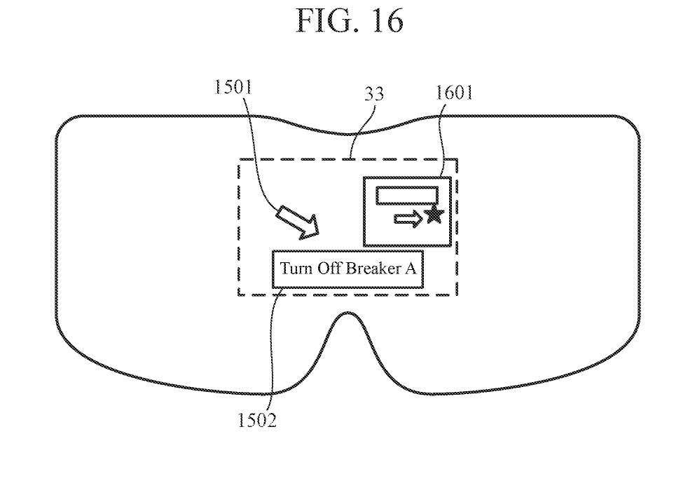

Note that by calculating also a display direction θ_{d2} of an overhead view in the calculation processing at step ST1202 illustrated in FIG. 12, it is possible to display an overhead view 1601 as illustrated in FIG. 16. Note that the display direction θ_{d2} can be obtained by the same calculation as that of the direction θ_{d} by projecting the direction vector Vd (Xd, Yd, Zd) onto the floor plane.

Furthermore, in a case where voice data is input by the communication unit 103, the voice output unit 108 reproduces the voice data (step ST1305). Then, the onsite worker listens to the voice instruction from the work instructor, asks a question or responds to confirmation, or takes other actions by the voice as well. The voice of the onsite worker is input by the voice input unit 107 and is transmitted to the instruction terminal 2 through a path opposite to that of the instructing voice of the work instructor. The work instructor listens to the voice of the onsite worker reproduced by the voice output unit 212 of the instruction terminal 2 and judges whether the previous instruction has been correctly understood and whether to further provide a next instruction.

As described above, according to the first embodiment, the instruction terminal 2 includes: the position direction estimating unit 204 for estimating a position and direction of the onsite worker from an image captured by the imaging unit 104 of the onsite terminal 1; the onsite situation image generating unit 205 for generating an image illustrating the onsite situation including the position of the onsite worker from the estimation result by the position direction estimating unit 204; the display unit 206 for displaying a screen including the image generated by the onsite situation image generating unit 205; the work instruction accepting unit 207 for accepting information indicating the next work position input by the work instructor on the screen displayed by the display unit 206; and the direction calculating unit 208 for calculating the direction to the next work position from the estimation result by the position direction estimating unit 204 and the acceptance result by the work instruction accepting unit 207. The onsite terminal 1 includes: the guide image generating unit 105 for generating an image indicating a direction to the next work position from the calculation result by the direction calculating unit 208; and the display unit 106 for displaying a screen including the image generated by the guide image generating unit 105. Therefore, it is possible to provide an instruction concerning a work target positioned outside an imaging angle of view of the imaging unit 104 for imaging an onsite image. Moreover, since it is possible to automatically calculate the direction from the current position to the next work position from the estimation result of the current position of the onsite worker and a direction in which the onsite worker is facing, the work instructor is not required to sequentially instruct a next work position. This enables smooth communication. As a result, communication between the onsite worker and the work instructor can be facilitated, and thus the work efficiency can be improved.

### Second Embodiment

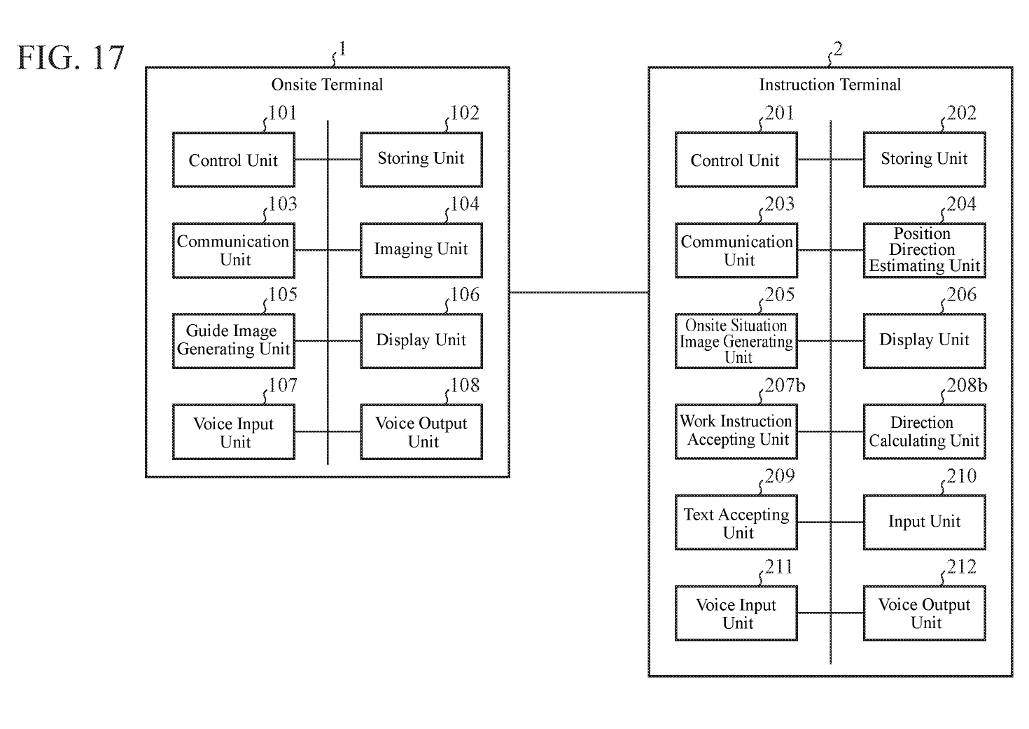

FIG. 17 is a diagram illustrating an overall configuration example of a remote work assistance device according to a second embodiment of the present invention. The remote work assistance device according to the second embodiment illustrated in FIG. 17 corresponds to the remote work assistance device according to the first embodiment illustrated in FIG. 1 in which the work instruction accepting unit 207 is replaced with a work instruction accepting unit 207b, and the direction calculating unit 208 is replaced with a direction calculating unit 208b. Other configurations are similar and thus denoted with the same symbols while only different points will be described.

The work instruction accepting unit 207b accepts information indicating a next work position and a route to the next work position input by a work instructor via an input unit 210. At this time, the work instructor designates the next work position and the route to the work position by using a work instruction screen displayed on a display 6 by a display unit 206.

The direction calculating unit 208b calculates, along the route, a direction from the current position of an onsite worker to the next work position on the basis of an estimation result by a position direction estimating unit 204 and an acceptance result by the work instruction accepting unit 207b.

Next, an exemplary operation of the remote work assistance device according to the second embodiment will be described. Note that the overall processing by the remote work assistance device is the same as the overall processing by the remote work assistance device according to the first embodiment, and thus descriptions thereof are omitted. Furthermore, onsite situation displaying processing and information presentation processing are also the same as the onsite situation displaying processing by the remote work assistance device according to the first embodiment, and thus descriptions thereof are omitted.

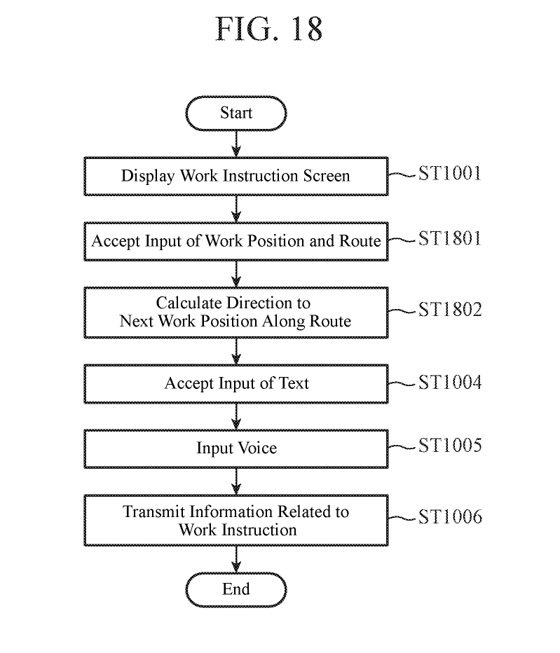

Next, details of work instruction accepting processing by the instruction terminal 2 in the second embodiment will be described with reference to FIG. 18. In the work instruction accepting processing by the instruction terminal 2 in the second embodiment illustrated in FIG. 18, steps ST1002 and ST1003 of the work instruction accepting processing by the instruction terminal 2 in the first embodiment illustrated in FIG. 10 are replaced with steps ST1801 and ST1802. The other processing is similar, and thus descriptions thereof are omitted.

In step ST1801, the work instruction accepting unit 207b accepts the next work position and information indicating the route to the work position input by the work instructor via the input unit 210. At this time, the work instructor designates the next work position and the route to the work position by using a work instruction screen displayed on the display 6 by the display unit 206.

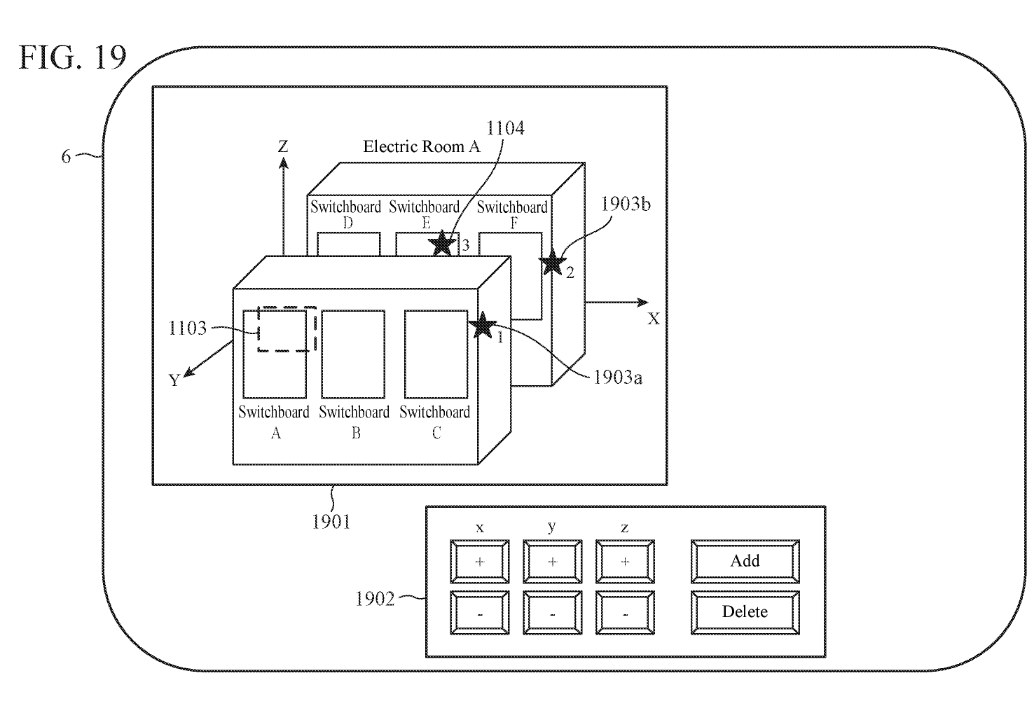

FIG. 19 is a diagram illustrating one example of a work instruction screen displayed by the display unit 206.

In the work instruction screen illustrated in FIG. 19, a virtual onsite image 1901 and an operation button 1902 are displayed. Note that the virtual onsite image 1901 is an image for the work instructor to designate the next work position together with the route to the work position and is a similar image to the virtual onsite image 1101 in FIG. 11. Furthermore, in the virtual onsite image 1901, a plurality of work route markers 1903 are added. The work route markers 1903 indicate a route to a next work position. Meanwhile, the operation button 1902 is a button image for adding and deleting the work route markers 1903 and moving a work position marker 1104 and the work route markers 1903. The operation button 1902 illustrated in FIG. 19 can perform addition and deletion of the work route markers 1903 and forward or backward operation of the work position marker 1104 and the work route markers 1903 in the axial directions (X, Y, Z). By operating the operation button 1902, the work instructor adds or deletes the work route markers 1903, moves the work position marker 1104 and the work route markers 1903, and designates the next work position and the route to the work position (coordinate values Pi (Xᵢ, Yᵢ, Zᵢ), i=1, 2, . . . , k). Alternatively, instead of button operation using the operation button 1902 as illustrated in FIG. 19, the work position marker 1104 and the work route markers 1903 may be moved by dragging operation thereof by a mouse. Note that FIG. 19 illustrates a case where k=3. While the onsite worker is in front of a switchboard A (the position of a frame line 1103), a route to the position of a switchboard E (work position marker 1104) that is the next work position is indicated by work route markers 1903a and 1903b.

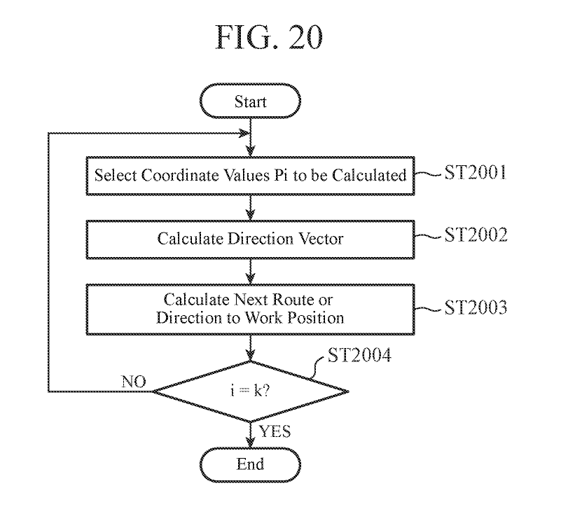

Next, the direction calculating unit 208b calculates, along the route, the direction from the current position of the onsite worker to the next work position on the basis of the estimation result by the position direction estimating unit 204 and the acceptance result by the work instruction accepting unit 207b (step ST1802). Hereinafter, details of the calculation processing by the direction calculating unit 208b will be described below with reference to FIG. 20.

In the calculation processing by the direction calculating unit 208b, as illustrated in FIG. 20, first, coordinate values Pi (Xᵢ, Yᵢ, Zᵢ) to be calculated is selected on the basis of the current position (coordinate values P0 (X₀, Y₀, Z₀)) of the onsite worker, the next work position, and the route to the work position (coordinate values Pi (Xᵢ, Yᵢ, Zᵢ)) (step ST2001). That is, from the positional relationship between P0 (X₀, Y₀, Z₀) and Pi (Xᵢ, Yᵢ, Zᵢ), Pi (X₀, Y₀, Z₀) closest to P0 Xᵢ, Yᵢ, Zᵢ) in a moving direction to the next work position is selected as a calculation object.

For example, in a case where the current position P0 (X₀, Y₀, Z₀) of the onsite worker is positioned between the position of the frame line 1103 and the position of the work route marker 1903a (coordinate values P1 (X₁, Y₁, Z₁)) illustrated in FIG. 19, the direction calculating unit 208b selects P1 (X₁, Y₁, Z₁) as the calculation object. Thereafter, in a case where the current position P0 (X₀, Y₀, Z₀) of the onsite worker falls within a threshold value with respect to P1 (X₁, Y₁, Z₁), the direction calculating unit 208b determines that the onsite worker has reached the position of the work route marker 1903a. In a case where the current position P0 (X₀, Y₀, Z₀) of the onsite worker is positioned between the position of the work route marker 1903a and the position of the work route marker 1903b (P2 (X₂, Y₂, Z₂)), the direction calculating unit 208b selects P2 (X₂, Y₂, Z₂) as the calculation object. Thereafter, in a case where the current position P0 (X₀, Y₀, Z₀) of the onsite worker falls within a threshold value with respect to P2 (X₂, Y₂, Z₂), the direction calculating unit 208b determines that the onsite worker has reached the position of the work route marker 1903b. In a case where the current position P0 (X₀, Y₀, Z₀) of the onsite worker is positioned between the position of the work route marker 1903b and the position of the work position marker 1104 (P3 (X₃, Y₃, Z₃)), the direction calculating unit 208b selects P3 (X₃, Y₃, Z₃) as the calculation object.

Next, the direction calculating unit 208b calculates a direction vector Vd (Xd, Yd, Zd) from P0 (X₀, Y₀, Z₀) to Pi (Xᵢ, Yᵢ, Zᵢ) on the basis of the current position (coordinate values P0 (X₀, Y₀, Z₀)) of the onsite worker and the selected coordinate values Pi (Xᵢ, Yᵢ, Zᵢ) (step ST2002). This processing is similar to the processing in step ST1201 in FIG. 12.

Next, on the basis of the calculated direction vector Vd (Xd, Yd, Zd) and the direction in which the onsite worker is facing (direction vector Vc (Xc, Yc, Zc)), the direction calculating unit 208b calculates a next route or a direction to a work position (step ST2003). This processing is similar to the processing in step ST1202 in FIG. 12.

Next, the direction calculating unit 208b determines whether calculation processing has been completed up to the next work position (coordinate values Pk (Xₖ, Yₖ, Zₖ)) (step ST2004). In step ST2004, if the direction calculating unit 208b determines that the calculation processing has been completed up to the next work position, the sequence ends.

On the other hand, in step ST2004, if the direction calculating unit 208b determines that the calculation processing has not been completed up to the next work position, the sequence returns to step ST2001, and the above processing is repeated.

As described above, according to the second embodiment, the work instruction accepting unit 207b accepts information indicating the next work position together with information indicating a route to the work position, and the direction calculating unit 208b calculates a direction to the next work position along the route. Therefore, in addition to the effects of the first embodiment, even in the case where it is necessary to move to a work position along a predetermined route, it is possible to smoothly provide an instruction.

### Third Embodiment

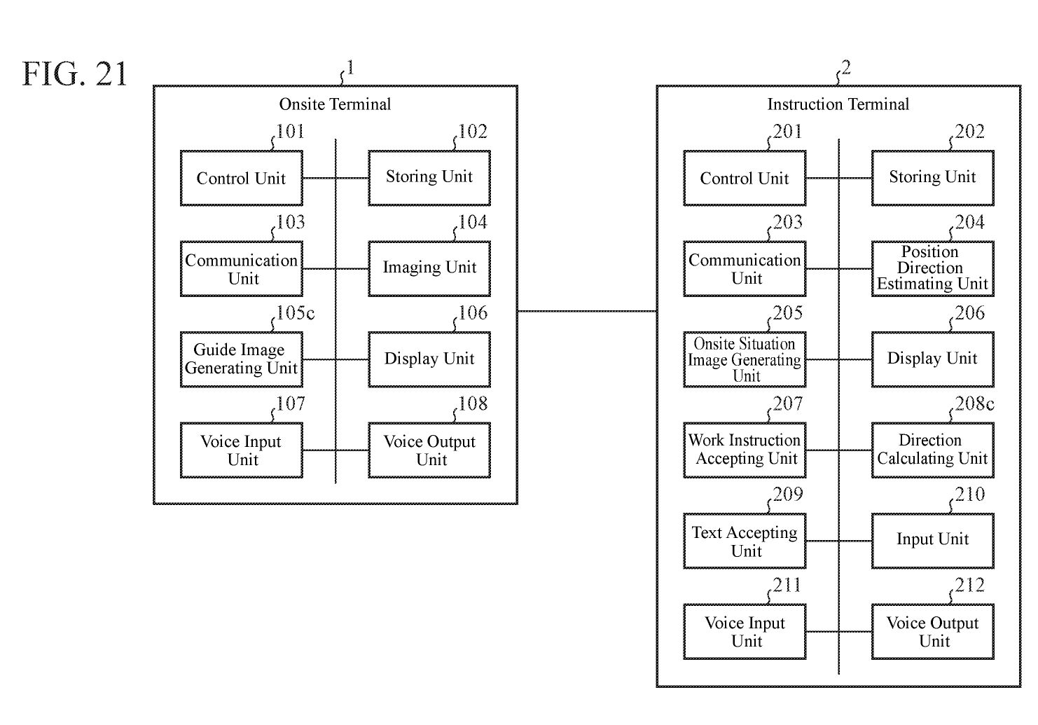

FIG. 21 is a diagram illustrating an overall configuration example of a remote work assistance device according to a third embodiment of the present invention. The remote work assistance device according to the third embodiment illustrated in FIG. 21 corresponds to the remote work assistance device according to the first embodiment illustrated in FIG. 1 in which the direction calculating unit 208 is replaced with a direction calculating unit 208c and the guide image generating unit 105 is replaced with a guide image generating unit 105c. Other configurations are similar and thus denoted with the same symbols while only different points will be described.

The direction calculating unit 208c calculates a direction from the current position of the onsite worker to the next work position in a three-dimensional space on the basis of an estimation result by a position direction estimating unit 204 and an acceptance result by a work instruction accepting unit 207.

The guide image generating unit 105c generates an image (guide image) indicating a direction, in the three-dimensional space, from the current position of the onsite worker to a next work position on the basis of the work instruction data received by a communication unit 103. Note that the guide image may be a mark like an arrow, for example.

Next, an exemplary operation of the remote work assistance device according to the third embodiment will be described. Note that the overall processing by the remote work assistance device is the same as the overall processing by the remote work assistance device according to the first embodiment, and thus descriptions thereof are omitted. Furthermore, onsite situation displaying processing is also the same as the onsite situation displaying processing by the instruction terminal 2 according to the first embodiment, and thus descriptions thereof are omitted.

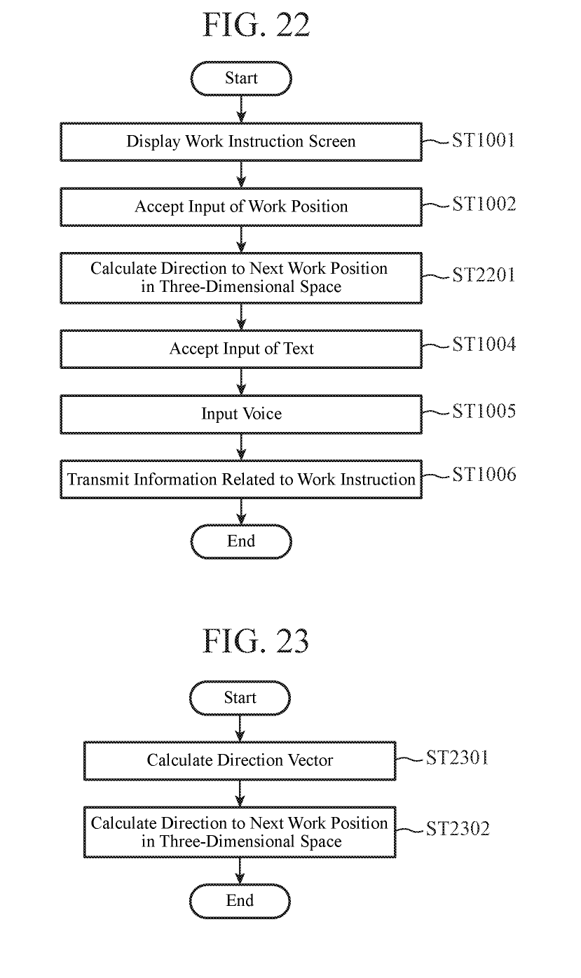

Next, details of work instruction accepting processing by an instruction terminal 2 in the third embodiment will be described with reference to FIG. 22. In the work instruction accepting processing by the instruction terminal 2 according to the third embodiment illustrated in FIG. 22, step ST1003 of the work instruction accepting processing by the instruction terminal 2 according to the first embodiment illustrated in FIG. 10 is replaced with step ST2201. The other processing is similar, and thus descriptions thereof are omitted.

In step ST2201, the direction calculating unit 208c calculates a direction from the current position of the onsite worker to the next work position in the three-dimensional space on the basis of the estimation result by the position direction estimating unit 204 and the acceptance result by the work instruction accepting unit 207. Details of the calculation processing by the direction calculating unit 208c will be described below with reference to FIG. 23.

As illustrated in FIG. 23, in the calculation processing by the direction calculating unit 208c, first a direction vector Vd (Xd, Yd, Zd) from P0 (X₀, Y₀, Z₀) to P1 (X₁, Y₁, Z₁) is calculated on the basis of the current position (coordinate values P0 (X₀, Y₀, Z₀)) of the onsite worker and the next work position (coordinate values P1 (X₁, Y₁, Z₁) (step ST2301).

Next, on the basis of the calculated direction vector Vd (Xd, Yd, Zd) and a direction in which the onsite worker is facing (direction vector Vc (Xc, Yc. Zc)), the direction calculating unit 208c calculates a direction to the next work position in the three-dimensional space (step ST2302). More specifically, the direction vector Vd (Xd, Yd, Zd) is projected while divided into a direction vector Vdr (Xdr, Ydr, Zdr) for right-eye projection and a direction vector Vdl (Xdl, Ydl, Zdl) for left-eye projection, on a plane having the direction vector Vc (Xc, Yc, Zc) as a normal vector thereto, and a direction θ_{d} from the center point of the onsite image (image captured by the imaging unit 104) is obtained. At this time, the inclination θ_{H} in the horizontal direction and the inclination θ_{V} in the vertical direction of the imaging device 32 estimated by the position direction estimating unit 204 may be modified considering the inclination of the head of the onsite worker.

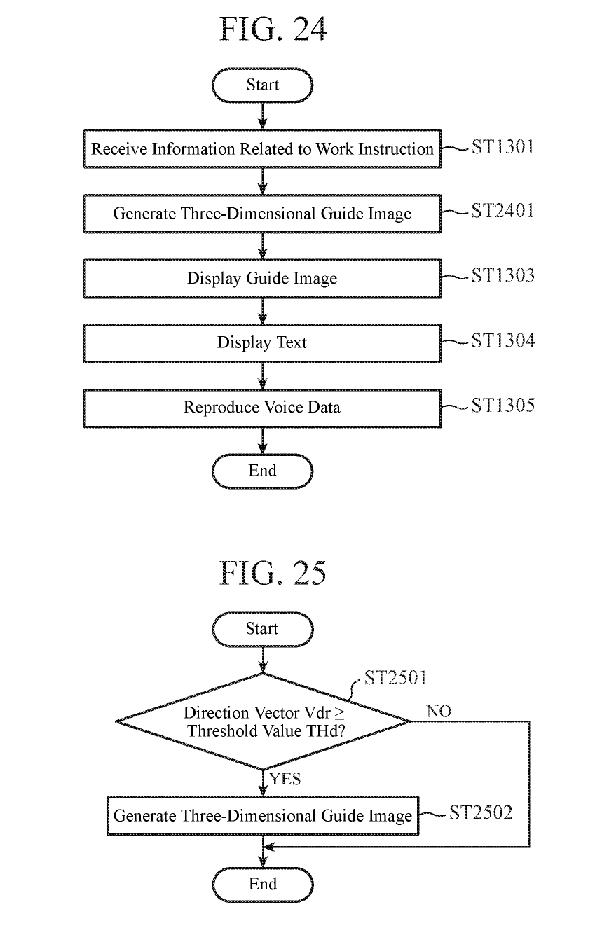

Next, details of information presentation processing by the onsite terminal 1 in the third embodiment will be described with reference to FIG. 24. In the information presentation processing by the onsite terminal 1 in the third embodiment illustrated in FIG. 24, the step STI1302 of the work instruction accepting processing by the instruction terminal 2 in the first embodiment illustrated in FIG. 13 is replaced with step ST2401. The other processing is similar, and thus descriptions thereof are omitted.

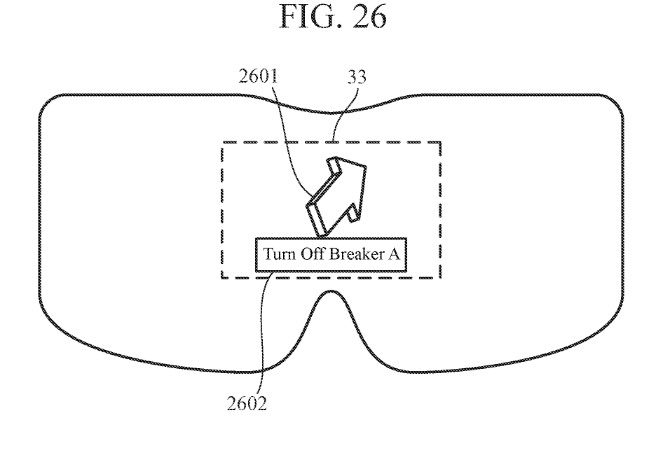

In step ST2401, on the basis of work instruction data received by the communication unit 103, the guide image generating unit 105c generates a guide image indicating a direction, in the three-dimensional space, from the current position of the onsite worker to the next work position. Details of the guide image generating processing by the guide image generating unit 105c will be described below with reference to FIG. 25. Note that, in the guide image generating processing illustrated in FIG. 25, only processing for the direction vector Vdr (Xdr, Ydr, Zdr) for the right eye projection is illustrated.

In the guide image generating processing by the guide image generating unit 105c, as illustrated in FIG. 25, it is first determined on the basis of the work instruction data whether the direction vector Vdr (Xdr, Ydr, Zdr) is larger than or equal to a predetermined threshold value THd (step ST2501). If it is determined in step ST2501 that the direction vector Vdr (Xdr, Ydr, Zdr) is less than the threshold value THd, the guide image generating unit 105c determines that displaying the guide image is unnecessary and terminates the processing.

On the other hand, if it is determined in step ST2501 that the direction vector Vdr (Xdr, Ydr, Zdr) is larger than or equal to the threshold value THd, the guide image generating unit 105c generates a guide image indicating, in the three-dimensional space, the direction from the current position of the onsite worker to the next work position (step ST2502). Note that the guide image may be a mark like an arrow, for example.

Similarly, the direction vector Vdl (Xdl, Ydl, Zdl) for the left-eye projection is also processed in a similar manner to the above.

Thereafter, the display unit 106 displays a screen (information presenting screen) including the guide image on the display 33 on the basis of the guide image generated by the guide image generating unit 105 (Step ST1303). As a result, the guide image, which is a three-dimensional image, is displayed on the display 33.

FIG. 26 is a diagram illustrating one example of an information presenting screen displayed by the display unit 106.

On the information presenting screen illustrated in FIG. 26, a guide image 2601 and a text 2602 are displayed. In the guide image 2601 illustrated in FIG. 26, an arrow indicating the direction from the current position of the onsite worker to the next work position is displayed three-dimensionally. Note that the text 2602 is the same as the text 1502 illustrated in FIG. 15. Therefore, the onsite worker can move to next work by looking at the guide image 2601 and the text 2602.

Note that the direction, in the three-dimensional space, from the current position of the onsite worker to the next work position is automatically calculated when the work instructor only designates the work position, and thus the work instructor is not required to sequentially instruct next work positions. This enables smooth communication.

As described above, according to the second embodiment, the direction calculating unit 208c calculates the direction to the next work position in the three-dimensional space, and the guide image generating unit 105c generates a three-dimensional image as the image indicating the direction to the next work position. Therefore, in addition to the effects in the first embodiment, it is possible to display the guide image in three dimensions to the onsite worker. This enables smooth communication.

Note that, within the scope of the present invention, the present invention may include a flexible combination of the respective embodiments, a modification of any component of the respective embodiments, or an omission of any component in the respective embodiments.

### INDUSTRIAL APPLICABILITY

The remote work assistance device according to the present invention is capable of providing an instruction concerning a work target positioned outside an imaging angle of view of the imaging unit for imaging an onsite image and is suitable for use as a remote work assistance device or the like including an onsite terminal having an imaging unit for capturing an image viewed from an onsite worker and an instruction terminal for transmitting and receiving information to and from the onsite terminal.

### REFERENCE SIGNS LIST

1: Onsite terminal, 2: Instruction terminal, 3, 3b: HMD, 4: Headset, 4b: Earphone microphone, 5: Control arithmetic device, 6: Display, 7: Input device, 8: Microphone, 9: Speaker, 10: Communication relay device, 31: Terminal unit, 32: Imaging device, 33: Display, 41: Microphone, 42: Speaker, 51: Processing circuit, 52: Storing device, 53: Communication device, 54: CPU, 55: Memory, 101: Control unit, 102: Storing unit, 103: Communication unit, 104: Imaging unit, 105, 105c: Guide image generating unit, 106: Display unit (onsite side display unit), 107: Voice input unit, 108: Voice output unit, 201: Control unit, 202: Storing unit, 203: Communication unit, 204: Position direction estimating unit, 205: Onsite situation image generating unit, 206: Display unit (instruction side display unit), 207, 207b: Work instruction accepting unit, 208, 208b, 208c: Direction calculating unit, 209: Text accepting unit, 210: Input unit, 211: Voice input unit, 212: Voice output unit, 311: Processing circuit, 312: Storing device, 313: Communication device, 314: CPU, 315: Memory.

1-5. (canceled)

6. A remote work assistance device, comprising:
an onsite terminal having an imaging device to capture an image viewed from a worker; and
an instruction terminal to transmit and receive information to and from the onsite terminal,
wherein the instruction terminal comprises: a first processing circuit
to estimate a position and direction of the worker from the image captured by the imaging device,
to generate an image indicating an onsite situation including the position of the worker from the estimation result,
to display a screen including the generated image,
to accept information indicating a next work position input by a work instructor on the displayed screen, and
to calculate a direction to the next work position from the estimation result and the acceptance result, and
the onsite terminal comprises: a second processing circuit
to generate an image indicating the direction to the next work position from the calculation result, and
to display a screen including the generated image.

7. The remote work assistance device according to claim 6,
wherein the first processing circuit accepts information indicating the next work position together with information indicating a route to the work position, and
the second processing circuit calculates the direction to the next work position along the route.

8. The remote work assistance device according to claim 6,
wherein the first processing circuit calculates the direction to the next work position in a three-dimensional space, and
the second processing circuit generates a three-dimensional image as the image indicating the direction to the next work position.

9. An instruction terminal, comprising:
a processing circuit
to estimate a position and direction of a worker from an image captured by an imaging device of an onsite terminal, the image viewed from the worker,
to generate an image indicating an onsite situation including the position of the worker from the estimation result,
to display a screen including the generated image,
to accept information indicating a next work position input by a work instructor on the displayed screen, and
to calculate a direction to the next work position from the estimation result and the acceptance result.

10. An onsite terminal, comprising:
an imaging device to capture an image viewed from a worker, and
a processing circuit to generate an image indicating a direction to a next work position from a calculation result of the direction to the next work position by an instruction terminal from an estimation result and an acceptance result when a position and direction of the worker are estimated by the instruction terminal from a captured image captured by the imaging device, the captured image indicating an onsite situation including the position of the worker is generated by the instruction terminal from the estimation result, a screen including the generated image is displayed by the instruction terminal, and information indicating the next work position input by a work instructor on the displayed screen is accepted by the instruction terminal, and
to display a screen including the generated image.
